(19) United States
(12) Patent Application Publication
(10) Pub. No.: US 2024/0316460 A1
(43) Pub. Date: Sep. 26, 2024

(54) METHOD FOR CONTROLLING VIRTUAL ITEM

(71) Applicant: Tencent Technology (Shenzhen) Company Limited, Shenzhen (CN)

(72) Inventor: Jieqi XIE, Shenzhen (CN)

(73) Assignee: Tencent Technology (Shenzhen) Company Limited, Shenzhen (CN)

(21) Appl. No.: 18/680,944

(22) Filed: May 31, 2024

Related U.S. Application Data
(63) Continuation of application No. PCT/CN2023/088692, filed on Apr. 17, 2023.

(30) Foreign Application Priority Data
Jun. 24, 2022 (CN) 202210728889.X

(51) Int. Cl. A63F 13/58; A63F 13/537

(52) U.S. Cl. CPC A63F 13/58; A63F 13/537

(57) ABSTRACT

In a method for controlling a virtual item, an inventory including a plurality of virtual items is displayed. A quantity selection interface for a first virtual item is displayed in response to a first sliding operation on a display element corresponding to the first virtual item from the plurality of virtual items. A quantity of the first virtual item is selected on the quantity selection interface based on the first sliding operation on the display element. A first operation is performed on a selected quantity of the first virtual item when the first sliding operation is released.

### RELATED APPLICATIONS

The present application is a continuation of International Application No. PCT/CN2023/088692, filed on Apr. 17, 2023, which claims priority to Chinese Patent Application No. 202210728889.X, filed on Jun. 24, 2022 and entitled “METHOD AND APPARATUS FOR CONTROLLING VIRTUAL ITEM, DEVICE, STORAGE MEDIUM, AND PROGRAM PRODUCT”. The entire disclosures of the prior applications are hereby incorporated by reference.

### FIELD OF THE TECHNOLOGY

This application relates to the field of Internet and computer technologies, including a method for controlling a virtual item.

### BACKGROUND OF THE DISCLOSURE

In some games, a user can perform a corresponding operation on an available virtual item to achieve an effect of using or transferring a virtual item.

In the related art, when a quantity of the virtual items is changed, the user needs to first select the virtual item and enter a number in a quantity selection interface of the virtual item, or manually drag a slider to determine a selected quantity of the virtual items, and then perform a determination operation. In response to the determination operation, a terminal device performs a corresponding operation on the selected quantity of virtual items, such as discarding, merging, and purchasing.

However, in the related art, the user needs to perform a cumbersome operation to change a quantity of the virtual items, which has low operation efficiency.

### SUMMARY

Embodiments of this disclosure provide a method, apparatus and a non-transitory computer-readable storage medium for controlling a virtual item Examples of technical solutions of this disclosure may be implemented as follows:

An aspect of this disclosure provides a method for controlling a virtual item, for example, in a method for controlling a virtual item, an inventory including a plurality of virtual items is displayed. A quantity selection interface for a first virtual item is displayed in response to a first sliding operation on a display element corresponding to the first virtual item from the plurality of virtual items. A quantity of the first virtual item is selected on the quantity selection interface based on the first sliding operation on the display element. A first operation is performed on a selected quantity of the first virtual item when the first sliding operation is released.

An aspect of this disclosure provides a data processing apparatus, including processing circuitry. The processing circuitry is configured to display an inventory including a plurality of virtual items. The processing circuitry is configured to display a quantity selection interface for a first virtual item in response to a first sliding operation on a display element corresponding to the first virtual item from the plurality of virtual items. The processing circuitry is configured to select a quantity of the first virtual item on the quantity selection interface based on the first sliding operation on the display element. The processing circuitry is configured to perform a first operation on a selected quantity of the first virtual item when the first sliding operation is released.

An aspect of this disclosure provides a non-transitory computer-readable storage medium storing instructions which when executed by a processor cause the processor to perform any of the methods of this disclosure.

The embodiments of this disclosure have the following beneficial effects.

The sliding operation is performed on the display entry (display element) of the first virtual item and released, so that the selected quantity for the first virtual item can be dynamically determined, and the first operation can be performed on the selected quantity of first virtual items. According to an aspect, in the embodiments of this disclosure, selection of the virtual item, adjustment of the selected quantity, and triggering of the first operation may be implemented only by performing a sliding operation. Through a single operation, the corresponding operation may be performed on some virtual items (such as discarding some virtual items), which fully improves convenience of the operation. According to an aspect, in the embodiments of this disclosure, coherence between a process of determining the selected quantity and performing the first operation can be improved, thereby improving fluency of the process of performing the first operation on the selected quantity of first virtual items. According to an aspect, compared with the tedious operation in the related art, only one sliding operation needs to be performed in the embodiments of this disclosure, which simplifies the operation and improves operation efficiency. In addition, since only one sliding operation needs to be performed, it is also helpful to reduce a probability of occurrence of a problem such as accidental touch, thereby increasing a success rate of the operation.

### BRIEF DESCRIPTION OF THE DRAWINGS

FIG. 1 is a schematic diagram of a solution implementation environment according to an embodiment.

FIG. 2 is a flowchart of a method for controlling a virtual item according to an embodiment.

FIG. 3 is a schematic diagram of a method for displaying an inventory according to an embodiment.

FIG. 4 is a schematic diagram of a control movement direction according to an embodiment.

FIG. 5 is a schematic diagram showing a change of a display position of a slider according to an embodiment.

FIG. 6 is a schematic diagram of a method for displaying a quantity selection interface according to an embodiment.

FIG. 7 is a schematic diagram of a method for determining a selected quantity according to an embodiment.

FIG. 8 is a schematic diagram of discarding a first virtual item according to an embodiment.

FIG. 9 is a schematic diagram of a second sliding operation according to an embodiment.

FIG. 10 is a schematic diagram of a method for controlling a virtual item according to an embodiment.

FIG. 11 is a block diagram of an apparatus for controlling a virtual item according to an embodiment.

FIG. 12 is a structural block diagram of a terminal device according to an embodiment.

### DESCRIPTION OF EMBODIMENTS

The objectives, technical solutions, and advantages in embodiments of this disclosure are described in further detail with reference to the accompanying drawings.

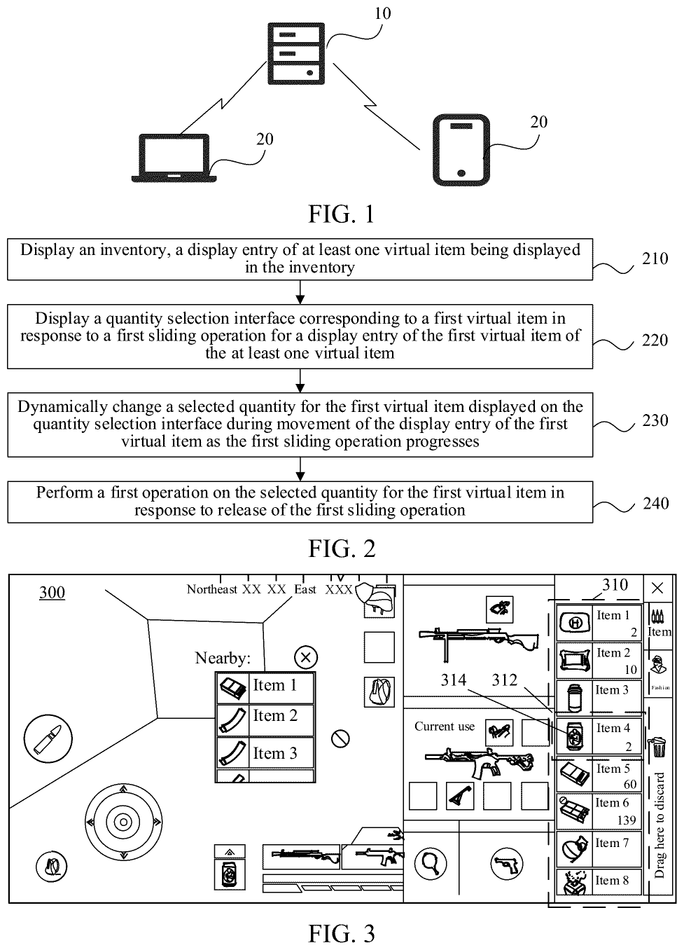

FIG. 1 is a schematic diagram of a solution implementation environment according to an embodiment of this disclosure. The solution implementation environment may be implemented as a computer system, such as a game application system. The solution implementation environment may include a terminal device 10 and a server 20.

The terminal device 10 may be an electronic device such as a mobile phone, a tablet computer, a personal computer (PC), a game console, a multimedia playback device, a wearable device, an intelligent voice interaction device, an intelligent home appliance, an on-board terminal, and an intelligent robot. In an example, the terminal device 10 has a target application installed and run therein. The target application may be a game application, a shopping application, a simulation learning application, a live streaming application, a social entertainment application, and the like. In some embodiments, the foregoing game application may include a first person shooting (FPS) game, an adventure game (ATG), an action game (ACT), a simulation game (SLG), and the like.

For example, an example in which the target application is the FPS application is used. The target application provides at least one virtual item for a user. The virtual item may be configured to have impact on an attribute of a first virtual object controlled by the user, or have impact on an attribute of a second virtual object in the target application not controlled by the user, such as a virtual attack prop, a virtual vehicle, a virtual defense prop, and a buff prop. In some embodiments, the user may perform a relevant operation on the virtual item, such as discarding, merging, picking up, purchasing, and selling.

The server 20 can provide a background service for the target application running on the terminal device 10. For example, the server 20 may be a background server of the target application. The server 20 may be an independent physical server, a server cluster composed of a plurality of physical servers or a distributed system, and may also be a cloud server that provides basic cloud computing services such as a cloud service, cloud computing, a cloud function, cloud storage, a network service, cloud communication, a domain name service, and an artificial intelligence platform. In some embodiments, the server 20 has at least functions such as data transceiving, storage, and calculation.

The terminal device 10 and the server 20 may communicate with each other through a network. The network may be a wired network or a wireless network.

In some embodiments, the game application is used as an example. The server 20 may be configured to provide game data for the game application running in the terminal device 10. For example, the server 20 may provide the game application with game data such as a virtual item and positions and a quantity of the virtual items placed in a virtual environment. The game application places a corresponding quantity of virtual items in corresponding positions in the virtual environment based on the game data provided by the server 20. In addition, in a case that a distance between the first virtual object controlled by the user and a specific virtual item satisfies a display distance, the game application displays the virtual item in the virtual environment.

FIG. 2 is a flowchart of a method for controlling a virtual item according to an embodiment of this disclosure. In an example, the method may be performed by the terminal device 10 in the solution implementation environment shown in FIG. 1. For example, the method may be performed by a client of a target application running on the terminal device 10. As shown in FIG. 2, the method may include the following operations (210 to 240):

Operation 210: Display an inventory, a display entry of at least one virtual item being displayed in the inventory. For example, an inventory including a plurality of virtual items is displayed.

The virtual item may be an item provided to a user account for use when the client of the target application runs on the terminal device. The virtual item may be a simulation of a real item, a semi-simulated and semi-fictitious item, or a purely fictitious item, which is not limited herein in this disclosure. In an example, the virtual item may be used in a virtual environment. The virtual environment may be an environment displayed (or provided) when the client of the target application runs on the terminal device. The virtual environment refers to an environment created for a virtual object to perform an activity (such as a game). For example, the environment may be a virtual house, a virtual island, virtual sky, or virtual land.

In some embodiments, the virtual item can have impact on attribute information of at least one virtual object in the virtual environment. For example, in a battle game, if the virtual item is an offensive prop, the virtual item may be configured to reduce a health point of the virtual object in the virtual environment. For another example, if the virtual item is an auxiliary prop, the virtual item may be configured to improve a status of the virtual object (such as the health point, a movement speed, and a field of view). In some other embodiments, the virtual item can have impact on the virtual environment. For example, if the virtual item is a construction material, the virtual item may be configured to construct a new structure in the virtual environment. A type and a function of the virtual item may be determined based on an actual need, which are not limited herein in this disclosure.

The inventory is configured to store or display at least one virtual item. In some embodiments, the display entry of at least one virtual item is displayed in the inventory. A display entry of a specific virtual item is configured to display information related to such virtual items. For example, at least one of the following is displayed in the display entry of the virtual item: identifier information of the virtual item, a total quantity of the virtual items, introduction to use of the virtual item, and the like. In this embodiment of this disclosure, a style of the inventory includes, but is not limited to, a backpack style, a shelving unit style, and a list style. A style of the display entry of the virtual item is not limited in this embodiment of this disclosure, such as an image-text combination style, an image style, and a text style. In some embodiments, display entries (display elements) of two different virtual items in the inventory may have the same display size or different display sizes.

In some embodiments, the identifier information of the virtual item is configured for identifying such virtual items, so that a user can quickly find display positions of such virtual items from the inventory based on the display entry of the virtual item. The identifier information of the virtual item may include at least one of the following: a name of the virtual item, an icon of the virtual item, a label of the virtual item, and the like.

In some embodiments, the total quantity of the virtual items may refer to a quantity of the virtual items that have been owned by the virtual object, i.e., a maximum quantity of such virtual items currently available to the user. For example, the display entry of the available virtual item is displayed in the inventory, and a total quantity of the available virtual items may be greater than or equal to 1. In other words, only the virtual item that the user may control in a current game progress is displayed in the inventory. For example, the inventory may be configured to display the virtual item stored in a virtual backpack carried by the virtual object. The virtual backpack may include all the virtual items currently owned by the virtual object. Then when the user opens the virtual backpack, the client displays an inventory corresponding to the virtual backpack. The display entries of all of the virtual items in the virtual backpack are tiled in the inventory in the form of a list. The display of the display entry of the available virtual item in the inventory helps reduce display of invalid information, thereby speeding up determination of the user to search for a virtual item in the inventory.

In some embodiments, the total quantity of the virtual items is changeable. For example, the total quantity of the virtual items may be reduced with a consumption behavior related to such virtual items. For example, the consumption behavior may include at least one of the following: a transfer operation for the virtual item, a use operation for the virtual item, a synthesis operation for the virtual item, and the like.

The transfer operation for the virtual item may mean discarding a specific quantity of virtual items in the virtual environment. For example, n virtual items A are discarded from the inventory in the virtual environment, n being a positive integer. Alternatively, the transfer operation for the virtual item may mean transferring a specific quantity of virtual items to other virtual objects in the virtual environment. For example, m virtual items B are transferred from the inventory to virtual backpacks of other virtual objects, m being a positive integer.

In some embodiments, the transfer operation for the virtual item does not change an attribute of the virtual item. For example, if a quantity a of virtual items C are discarded by the user in the virtual environment, the virtual items C may still be used after being picked up by another virtual object.

In some embodiments, the use operation for the virtual item may refer to an operation that causes the virtual item to function. For example, a specific virtual item is configured to increase the health point of the virtual object. The virtual object may be any virtual object existing within a range of action of the virtual item in the virtual environment. After a quantity b of such virtual items are used on the virtual object, the health point of the virtual object increases, and the total quantity of such virtual items decreases by b, b being a positive integer.

In some embodiments, the total quantity of the virtual items increases as an obtaining behavior related to the virtual item is performed. For example, in the FPS game, the obtaining behavior may include at least one of the following: picking up such virtual items in the virtual environment, transferring another virtual object in a game, and a corresponding reward after a task is completed. For another example, in a SIM game, the obtaining behavior may include at least one of the following: a manufacturing behavior for such virtual items, picking up such virtual items in the virtual environment, and transferring another virtual object in a game.

FIG. 3 is a schematic diagram of a method for displaying an inventory according to an embodiment of this disclosure. In FIG. 3, an inventory 310 is displayed at an edge position of a display interface 300, and display entries respectively corresponding to 8 virtual items are displayed in the inventory 310. A display entry 312 is configured to indicate a virtual item “beverage”. A name (“item 4”) of the virtual item, an icon 314 of the virtual item, and a total quantity (“2”) of the virtual items are displayed in the display entry 312.

Operation 220: Display a quantity selection interface corresponding to a first virtual item in response to a first sliding operation for a display entry of the first virtual item of at least one virtual item. For example, a quantity selection interface for a first virtual item is displayed in response to a first sliding operation on a display element corresponding to the first virtual item from the plurality of virtual items.

The foregoing first virtual item may refer to one or more virtual items having display entries displayed in the inventory. The first virtual item in this embodiment of this disclosure may also be referred to as a target virtual item to refer to any one or more virtual items in the at least one virtual item. For example, a display entry of a virtual item 1, a display entry of a virtual item 2, a display entry of a virtual item 3, and a display entry of a virtual item 4 are displayed in the inventory. In this case, the first virtual item may refer to any one or more of the virtual item 1, the virtual item 2, the virtual item 3, and the virtual item 4. For example, the first virtual item is the virtual item 1. For another example, the first virtual item may include the virtual item 2 and the virtual item 4, which is not limited herein in this disclosure.

In some embodiments, a terminal device determines a display entry of at least one virtual item in the inventory in response to a display entry selection operation. The display entry selection operation may include a clicking/tapping operation, a sliding operation, a key operation, and the like. In some embodiments, the display entry selection operation may be triggered by a user through a display screen of the terminal device, or may be triggered by an external control device of the terminal device, such as a mouse, a keyboard, and a handle.

In some embodiments, the first sliding operation refers to a sliding operation triggered in a display region of the display entry of the first virtual item. For example, the first sliding operation may be a sliding operation in a specific sliding direction, such as a sliding operation to the left by using a finger for the display entry of the first virtual item.

In some embodiments, a quantity selection interface corresponding to the first virtual item is configured to display a selected quantity for the first virtual item. The selected quantity for the first virtual item refers to a quantity of first virtual objects selected by the user. In some embodiments, at least one of the following is displayed on the quantity selection interface corresponding to the first virtual item: a number identifier and a proportion identifier, to characterize the selected quantity for the first virtual item. The selected quantity for the first virtual item displayed on the quantity selection interface is greater than or equal to 0, and is less than or equal to a total quantity of the first virtual items. In a case that the total quantity of the first virtual items is greater than 1, the selected quantity for the first virtual item changes with a movement process of the first sliding operation.

To facilitate control of a distance of the first sliding operation by the user, the quantity selection interface corresponding to the first virtual item and the inventory may be simultaneously displayed on a user interface. In this way, the user may adjust the first sliding operation based on a change of the selected quantity on the quantity selection interface, for example, change the selected quantity by adjusting a sliding distance of the first sliding operation.

In some embodiments, no overlap exists between a display position of the quantity selection interface corresponding to the first virtual item and a display position of the inventory.

For example, the inventory is displayed in a right region of the user interface. The quantity selection interface corresponding to the first virtual item is displayed in a middle region of the user interface. A minimum distance between a boundary of the quantity selection interface corresponding to the first virtual item and a boundary of the inventory is less than or equal to i pixels, i being a natural number.

For another example, the inventory is displayed in a first region of the user interface. The quantity selection interface corresponding to the first virtual item is displayed in a second region below the first region. A minimum distance between the first region and the second region is greater than or equal to j pixels, j being a natural number.

In some other embodiments, an overlap exists between the display position of the quantity selection interface corresponding to the first virtual item and the display position of the inventory on the user interface. In some embodiments, the quantity selection interface corresponding to the first virtual item is displayed around the display entry of the first virtual item. For example, the quantity selection interface corresponding to the first virtual item is displayed below the display entry of the first virtual item. The quantity selection interface corresponding to the first virtual item temporarily partially covers (for example, completely covers or semi-transparently covers) another display entry around the display entry of the first virtual item.

A display region of the quantity selection interface of the first virtual item may be set based on an actual condition, which is not limited herein in this disclosure.

Operation 230: Dynamically change a selected quantity for the first virtual item displayed on the quantity selection interface during movement of the display entry of the first virtual item as the first sliding operation progresses. For example, a quantity of the first virtual item on the quantity selection interface is selected based on the first sliding operation on the display element.

In this embodiment of this disclosure, the display entry of the virtual item may be moved as the sliding operation progresses. In this way, the user may be given an intuitive feeling of an effect of the sliding operation, which helps improve accuracy of controlling the sliding operation by the user.

In some embodiments, the selected quantity for the first virtual item may vary in correlation with the sliding distance of the first sliding operation. For example, a larger sliding distance of the first sliding operation indicates a larger value of the selected quantity for the first virtual item, or a larger sliding distance of the first sliding operation indicates a smaller value of the selected quantity for the first virtual item. The display entry of the first virtual item may also vary in correlation with the sliding distance of the first sliding operation. For example, a larger sliding distance of the first sliding operation indicates a larger displacement value of the display entry of the first virtual item.

In some embodiments, a client displays an initial selected quantity for the first virtual item on the quantity selection interface corresponding to the first virtual item in response to the first sliding operation for the display entry of the first virtual item. During movement of the display entry of the first virtual item as the first sliding operation progresses, the client changes the initial selected quantity, and determines a value of a changed selected quantity corresponding to the first virtual items based on the first sliding operation.

For example, the initial selected quantity for the first virtual item is 0. During movement of the display entry of the first virtual item as the first sliding operation progresses, the value of the selected quantity for the first virtual item displayed on the quantity selection interface continuously increases until the selected quantity for the first virtual item is equal to the total quantity of the first virtual items.

For another example, the initial selected quantity for the first virtual item is the total quantity of the first virtual items. The client displays the initial selected quantity for the first virtual item on the quantity selection interface in response to the first sliding operation for the display entry of the first virtual item. During movement of the display entry of the first virtual item as the first sliding operation progresses, the selected quantity for the first virtual item displayed on the quantity display interface continuously decreases until the value of the selected quantity for the first virtual item is equal to x, where x=0, 1. Regarding details of the process, reference is made to the following embodiments, and the details are not described herein again.

Operation 240: Perform a first operation on a selected quantity of first virtual items in response to release of the first sliding operation. For example, a first operation is performed on a selected quantity of the first virtual item when the first sliding operation is released.

The release of the first sliding operation refers to an end of the first sliding operation. For example, the user stops sliding and controls a finger (or a touch screen device) to leave a display screen of a terminal device, and the terminal device no longer receives information related to the first sliding operation. In some embodiments, in a case that the terminal device senses that the finger that triggers the first sliding operation is far away from a screen of the terminal device (for example, a pressure at a contact point between the first sliding operation and the terminal device is less than a pressure threshold), the terminal device may recognize the release of the first sliding operation. Alternatively, in a case that the terminal device senses that the finger that triggers the first sliding operation is separated from the screen of the terminal device, the terminal device may recognize the release of the first sliding operation.

In some embodiments, the first operation refers to an operation that can be performed on a virtual item in a game. For example, the first operation may include at least one of the following: discarding the selected quantity of first virtual items in a virtual environment, transferring the selected quantity of first virtual items to another virtual object, and using the selected quantity of first virtual items all at one time, which is not limited herein in this disclosure.

In some embodiments, the first operation can change the total quantity of the first virtual items. For example, the selected quantity for the first virtual item is 3, and the total quantity of the first virtual items is 5. After the terminal device performs a first operation on the selected quantity of first virtual items, the total quantity of the first virtual items is changed to 2 (a calculation method is 5-3).

Based on the above, according to the technical solutions provided in the embodiments of this disclosure, the sliding operation is performed on the display entry of the first virtual item and released, so that the selected quantity for the first virtual item can be dynamically determined, and the first operation can be performed on the selected quantity of first virtual items. According to an aspect, in the embodiments of this disclosure, selection of the virtual item, adjustment of the selected quantity, and triggering of the first operation may be implemented only by performing a sliding operation. Through a single operation, the corresponding operation may be performed on some virtual items (such as discarding some virtual items), which fully improves convenience of the operation. According to an aspect, in the embodiments of this disclosure, coherence between a process of determining the selected quantity and performing the first operation can be improved, thereby improving fluency of the process of performing the first operation on the selected quantity of first virtual items. According to an aspect, compared with the tedious operation in the related art, only one sliding operation needs to be performed in the embodiments of this disclosure, which simplifies the operation and improves operation efficiency. In addition, since only one sliding operation needs to be performed, it is also helpful to reduce a probability of occurrence of a problem such as accidental touch, thereby increasing a success rate of the operation.

Next, a process of dynamically changing the selected quantity for the first virtual item is described by using several embodiments.

In some embodiments, a slider bar and a slider located on the slider bar are displayed on the foregoing quantity selection interface, and a display position of the slider on the slider bar is configured to display a proportional relationship between the selected quantity for the first virtual item and a total quantity of the first virtual items. The dynamically changing, by the terminal device, a selected quantity for the first virtual item displayed on the quantity selection interface during movement of the display entry of the first virtual item as the first sliding operation progresses includes: determining, by the terminal device, the selected quantity for the first virtual item based on a sliding distance of the first sliding operation during the movement of the display entry of the first virtual item as the first sliding operation progresses; and dynamically changing, by the terminal device, the display position of the slider on the slider bar with a change in the selected quantity for the first virtual item, to display the proportional relationship between the selected quantity for the first virtual item and the total quantity of the first virtual items.

The slider on the slider bar may be moved to any position on the slider bar. For different positions of the slider on the slider bar, selected quantities for the first virtual items corresponding to the positions are not exactly the same. A correspondence between the selected quantity and the first sliding operation is indicated by the slider bar and the slider, so that the user adjusts the selected quantity for the first virtual item more visually, which is beneficial to improving accuracy of the operation.

In some embodiments, a sliding operation of the slider on the slider bar is consistent with a sliding direction of the first sliding operation. In other words, a distribution direction of the slider bar on the quantity selection interface is also consistent with the sliding direction of the first sliding operation. For example, if the sliding direction of the first sliding operation is in a horizontal direction, the slider bar is displayed in the horizontal direction on the quantity selection interface. For another example, if the sliding direction of the first sliding operation is in a vertical direction, the slider bar is displayed in the vertical direction on the quantity selection interface. By supporting the consistency between a moving direction of the slider on the slider bar and the sliding direction of the first sliding operation, and the consistency between the distribution direction of the slider bar and the sliding direction of the first sliding operation, the user may visually perceive impact of the first sliding operation on the selected quantity, which further improve the accuracy of the operation.

The sliding distance of the first sliding operation refers to a moving distance of the first sliding operation in the sliding direction. The moving distance may be calculated based on coordinates of a current contact point corresponding to the first sliding operation and coordinates of an initial contact point of the first sliding operation.

In some embodiments, the selected quantity for the first virtual item is proportional to the sliding distance of the first sliding operation. In other words, the selected quantity for the first virtual item increases with an increase in the sliding distance of the first sliding operation until the selected quantity for the first virtual item is equal to the total quantity of the first virtual items. Alternatively, the selected quantity for the first virtual item decreases with a decrease in the sliding distance of the first sliding operation until the selected quantity for the first virtual item is equal to 0 or 1.

In some embodiments, the selected quantity for the first virtual item is inversely proportional to the sliding distance of the first sliding operation. In other words, the selected quantity for the first virtual item decreases with an increase in the sliding distance of the first sliding operation until the selected quantity for the first virtual item is equal to 0 or 1. Alternatively, the selected quantity for the first virtual item increases with a decrease in the sliding distance of the first sliding operation until the selected quantity for the first virtual item is equal to the total quantity of the first virtual items.

In some embodiments, the terminal device determines the selected quantity for the first virtual item based on the sliding distance of the first sliding operation or the moving distance of the display entry of the first virtual item. The moving distance of the display entry of the first virtual item refers to a distance that the display entry of the first virtual item moves as the first sliding operation progresses. The moving distance of the display entry of the first virtual item may be calculated based on a current position of the display entry of the first virtual item and an initial position of the display entry of the first virtual item. In some embodiments, if the sliding distance of the first sliding operation is greater than or equal to the moving distance of the display entry of the first virtual item, a movement amplitude of the display entry of the first virtual item may be determined by reducing a sliding amplitude of the first sliding operation that is proportional to the movement amplitude.

In some embodiments, during the movement of the display entry of the first virtual item as the first sliding operation progresses, the terminal device cancels display of a part of the display entry of the first virtual item that exceeds the inventory, to avoid blocking another display content as a result of the movement of the display entry of the first virtual item.

In some embodiments, the terminal device causes the display entry of the first virtual item to move as the first sliding operation progresses, which is completed by setting a mobile control at a display position of the display entry of the first virtual item.

For example, the mobile control may be determined based on a complete display entry. For example, a style and an initial display position of the mobile control are determined by using the complete display entry. In some embodiments, a movable direction of the mobile control is related to the sliding direction of the first sliding operation. For example, the movable direction of the mobile control is consistent with the sliding direction of the first sliding operation. In some embodiments, movement of the mobile control is limited by a movement range, and the mobile control can only move within the movement range. For example, the movement range of the mobile control is the same as a display region of the display entry of the first virtual item. To be specific, a complete display region of the display entry is the movement range of the mobile control.

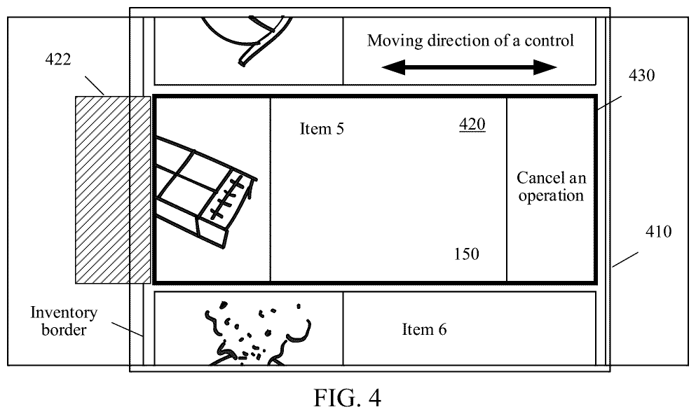

For example, FIG. 4 is a schematic diagram of a control movement direction according to an embodiment of this disclosure. In FIG. 4, a moving direction of a mobile control corresponding to a display entry 420 of a first virtual item in an inventory 410 is a horizontal direction. The mobile control corresponding to the display entry 420 of the first virtual item moves within a movement range 430. The movement range 430 is a complete display region of the display entry 420. During the movement of the display entry 420 of the first virtual item as a first sliding operation progresses, a terminal device cancels display of a part 422 of the display entry 420 of the first virtual item that exceeds the inventory 410.

In some embodiments, the determining, by the terminal device, the selected quantity for the first virtual item based on a sliding distance of the first sliding operation includes: obtaining, by the terminal device, a ratio of the sliding distance of the first sliding operation to a rated maximum sliding distance (predetermined maximum sliding distance); and determining, by the terminal device, the selected quantity for the first virtual item based on the ratio and the total quantity of the first virtual items.

The rated maximum sliding distance refers to a maximum sliding distance that may be reached by the first sliding operation. The rated maximum sliding distance is less than or equal to a display size of a user interface. To reduce blocking of a screen displayed on the user interface by a finger during the first sliding operation by a user, and shorten time consumed by the user to determine the selected quantity for the first virtual item through the first sliding operation, the rated maximum sliding distance is usually less than the display size of the user interface. In some embodiments, the rated maximum sliding distance is preset. For example, the rated maximum sliding distance is related to the display size of the user interface.

In some embodiments, the rated maximum sliding distance is related to the display size of the display entry of the first virtual item. For example, if the display entry of the first virtual item is a rectangle and a longer side includes k pixels, the rated maximum sliding distance is equal to k pixels, k being a positive integer. An effective range of the first sliding operation is limited by setting the rated maximum sliding distance, which helps limit the first sliding operation performed by the user within the rated maximum sliding distance and avoid accidental touch of another control during the first sliding operation.

For example, if the sliding distance of the first sliding operation is 20 pixels and the rated maximum sliding distance is 50 pixels, the ratio of the sliding distance of the first sliding operation to the rated maximum sliding distance calculated by the terminal device is equal to 0.4.

In some embodiments, the terminal device determines the selected quantity for the first virtual item by calculating a product of the foregoing ratio and the total quantity of the first virtual items. For example, assuming that the calculated ratio is 0.7 and the total quantity of the first virtual items is 10, the selected quantity for the first virtual item is equal to 0.7*10=7. Since the selected quantity for the first virtual item is a natural number, a rounding operation needs to be performed on the product in a case that a decimal occurs in the product of the ratio and the total quantity of the first virtual items. The round operation may be a round up operation. For example, 1.4 is rounded up to 2. The round operation may also be a round down operation. For example, 1.4 is rounded down to 1. Assuming that a total quantity of certain first virtual items is 6, and during sliding of the slider as the first sliding operation progresses, a case in which the ratio is equal to 0.6 exists, the selected quantity for the first virtual item is equal to 0.6*6=3.6, which may be rounded up to 4.

In some embodiments, during movement of the display entry of the first virtual item as the first sliding operation progresses, the terminal device may update and calculate the selected quantity for the first virtual item based on a fixed time interval. For example, the terminal device recalculates the selected quantity for the first virtual item every 0.2 seconds. During the first sliding operation, the slider also performs a corresponding sliding operation on the slider bar to indicate that the selected quantity for the first virtual item constantly changes.

For example, if the sliding direction of the first sliding operation is from left to right, the moving direction of the slider on the slider bar is also from left to right. For another example, if the sliding direction of the first sliding operation is from top to bottom, the moving direction of the slider on the slider bar is also from top to bottom.

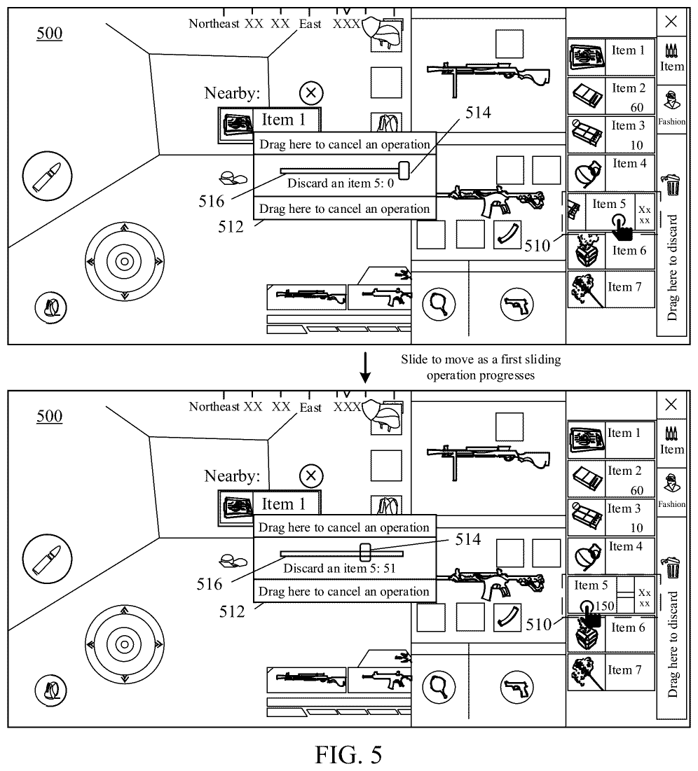

For example, FIG. 5 is a schematic diagram showing a change of a display position of a slider according to an embodiment of this disclosure. In a display screen 500, a terminal device displays a quantity selection interface 512 corresponding to a first virtual item in response to a first sliding operation for a display entry 510 of the first virtual item. A slider 514 on the quantity selection interface 512 is displayed on a rightmost side of a slider bar 516. In this case, a selected quantity for the first virtual item is 0. With a continuous increase in the sliding distance of the first sliding operation, the slider 514 and the display entry 510 begin to change. As the first sliding operation progresses, the terminal device displays, on the quantity selection interface 512, that the slider 514 moves to the left along the slider bar 516 and that the display entry 510 moves to the left. In this case, the selected quantity for the first virtual item is changed from 0 to 51.

It is not difficult to understand from the foregoing description that since the display entry of the first virtual item can moved as the first sliding operation progresses, in some embodiments, a moving direction of the slider on the slider bar, a sliding direction of the first sliding operation, and a moving direction of the display entry of the first virtual item are consistent. For example, if the sliding direction of the first sliding operation is from left to right, the moving direction of the slider on the slider bar is from left to right, and the moving direction of the display entry of the first virtual item is also from left to right.

Through the foregoing method, the user may quickly determine the selected quantity for the first virtual item through the first sliding operation, which helps simplify an operation to be performed by the user for performing a first operation on the selected quantity of first virtual items. In this way, the user operates virtual items in an inventory more smoothly during a game, which helps improve gaming experience of the user.

Next, a process of displaying the quantity selection interface is described by using several embodiments.

In some embodiments, the displaying, by the terminal device, a quantity selection interface corresponding to a first virtual item in response to a first sliding operation for a display entry of the first virtual item of at least one virtual item includes: controlling, by the terminal device in response to the first sliding operation for the display entry of the first virtual item, the display entry of the first virtual item to move as the first sliding operation progresses; and displaying, by the terminal device, the quantity selection interface corresponding to the first virtual item when a moving distance of the display entry of the first virtual item reaches a first threshold. The quantity selection interface is displayed in a case that the first sliding operation satisfies a condition, which may avoid meaningless and accidental display of the quantity selection interface due to an accidental operation performed by the user, thereby ensuring user experience.

In some embodiments, the moving direction of the display entry of the first virtual item is consistent with the sliding direction of the first sliding operation. For example, if the sliding direction of the first sliding operation is from right to left, the moving direction of the display entry of the first virtual item is also from right to left.

To adapt a movement process of the display entry of the first virtual item displayed on the user interface to the sliding process of the first sliding operation, so that the movement of the display entry of the first virtual item can provide a reference for the sliding distance required by the first sliding operation, a movement speed of the display entry of the first virtual item is related to a sliding speed of the first sliding operation. For example, the movement speed of the display entry of the first virtual item is equal to the sliding speed of the first sliding operation.

The terminal device controls the movement speed of the display entry of the first virtual item based on the sliding speed of the first sliding operation, so that the movement of the display entry of the first virtual item is adapted to the sliding process of the first sliding operation. During performing of the first sliding operation, the terminal device can display a corresponding screen, which is convenient for the user obtain feedback information corresponding to the first sliding operation (the movement process of the display entry of the first virtual item), so that the first sliding operation is more interactive.

In some embodiments, in a case that the sliding distance of the first sliding operation is less than or equal to the first threshold, the terminal device controls prompt information to be gradually moved into and displayed at a position from which the display entry of the first virtual item is moved away while controlling the display entry of the first virtual item to move as the first sliding operation progresses. The prompt information is configured for prompting the user that the first sliding operation is invalid in a case that the sliding distance is less than or equal to the first threshold, i.e., no impact is caused on the user interface.

In some embodiments, a method for canceling the first sliding operation is related to the sliding direction of the first sliding operation. For example, the method for canceling the first sliding operation is changing the sliding direction of the first sliding operation. For example, if the sliding direction of the first sliding operation is from right to left, the method for canceling the first sliding operation may be adjusting the sliding direction of the first sliding operation from left to right, adjusting the sliding direction of the first sliding operation to downward, adjusting the sliding direction of the first sliding operation to upward, and the like.

In a case that the quantity selection interface corresponding to the first virtual item is not displayed, the terminal device repeatedly determines whether a sliding distance of a current first sliding operation is greater than or equal to the first threshold as the first sliding operation progresses. If the sliding distance of the first sliding operation is less than the first threshold, the terminal device continues to monitor a magnitude relationship between the sliding distance of the first sliding operation and the first threshold. If the first sliding operation is greater than or equal to the first threshold, the terminal device displays the quantity selection interface corresponding to the first virtual item.

In some embodiments, the first threshold is less than or equal to a length of the display entry of the first virtual item. For example, if the length of the display entry of the first virtual item is 300 pixels, the first threshold may be 45 pixels, 60 pixels, 80 pixels, and the like. A value of the foregoing first threshold may be determined based on an actual condition such as a display length of the display entry of the first virtual item, which is not limited herein in this disclosure.

In some embodiments, the quantity selection interface is also configured to display a condition in which the selected quantity for the first virtual item changes as the first sliding operation progresses. For example, during the performing of the first sliding operation, the quantity selection interface dynamically adjusts and displays a value of the selected quantity for the first virtual item.

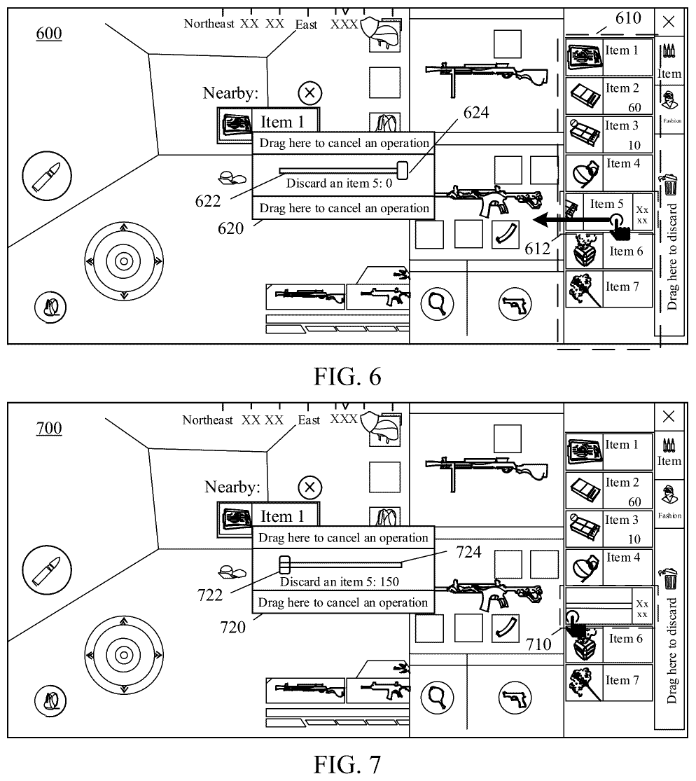

For example, FIG. 6 is a schematic diagram of a method for displaying a quantity selection interface according to an embodiment of this disclosure. In FIG. 6, an inventory 610 is displayed on a display interface 600. A user may determine a display entry 612 of a first virtual item through a first sliding operation, and move the display entry 612 of the first virtual item (a sliding direction of the first sliding operation in FIG. 6 is horizontal sliding to the left). A terminal device displays a quantity selection interface 620 in response to the first sliding operation in a case that a sliding distance of the first sliding operation is greater than or equal to a first threshold. A slider bar 622 and a slider 624 on the slider bar 622 are displayed on the quantity selection interface 620. A name of the first virtual item (an item 5) and a selected quantity (“0”) of the first virtual items are also displayed on the quantity selection interface 620. A prompt related to an operation to be performed on the selected quantity of first virtual items is also displayed on the quantity selection interface 620: “discard”, which represents that the first sliding operation is configured for discarding the selected quantity of first virtual items in a virtual environment.

By setting the slider to move as the first sliding operation progresses, a user does not need to manually adjust a position of the slider on the slider bar after the quantity selection interface is displayed. In this way, an operation required to perform the first operation on the selected quantity of first virtual items is reduced, which helps simplify the operation performed by the user and improve fluency of the operation of discarding some virtual items.

In some embodiments, in addition to the slider and slider bar, at least one of the following is also displayed on the quantity selection interface: a total quantity of the first virtual items, the selected quantity for the first virtual item corresponding to a position of the slider on the slider bar, operation prompt information, and the like. In some embodiments, after the quantity selection interface corresponding to the first virtual item is displayed, the slider on the quantity selection interface starts to move on the slider bar as the first sliding operation progresses. In a case that the user causes the selected quantity for the first virtual item to reach an expected quantity through the first sliding operation, the user stops performing the first sliding operation. When the terminal device detects release of the first sliding operation, the terminal device performs a first operation on the selected quantity of first virtual items.

In some embodiments, in a case that the sliding distance of the first sliding operation is greater than the first threshold and less than a second threshold, the terminal device determines the selected quantity for the first virtual item based on the sliding distance of the first sliding operation and the total quantity of the first virtual items. In a case that the sliding distance of the first sliding operation is greater than or equal to the second threshold, the terminal device uses the total quantity of the first virtual items as the selected quantity for the first virtual item.

The first threshold is less than the second threshold. The first threshold and the second threshold may be preset. For example, the second threshold is equal to a size of a longer side of the display entry of the first virtual item, and the first threshold is equal to one fifth of the second threshold. Specific setting methods of the first threshold and the second threshold are determined based on an actual condition, which is not limited herein in this disclosure.

For example, FIG. 7 is a schematic diagram of a method for determining a selected quantity according to an embodiment of this disclosure. In a case that a sliding distance of a first sliding operation is greater than or equal to a second threshold, display of a display entry 710 of a first virtual item is completely canceled, and on a quantity selection interface 720, a slider 722 slides to a leftmost side of a slider bar 724. In this case, a selected quantity for the first virtual item is equal to a total quantity of the first virtual items.

A first sliding operation is performed on a display entry of the first virtual item, to implement a dynamic change of the selected quantity for the first virtual item from 0 to the total quantity of the first virtual items based on a distance of the first sliding operation, so that a manner of determining the selected quantity for the first virtual item is simpler.

In some embodiments, the performing, by a terminal device, a first operation on the selected quantity of first virtual items includes: discarding, by the terminal device, the selected quantity of first virtual items. In this way, some virtual items may be quickly discarded only through an interactive operation, thereby improving efficiency and convenience of discarding some virtual items.

Discarding the selected quantity of first virtual items may be understood as discarding the selected quantity of first virtual items in a virtual environment, and the discarded first virtual items cannot be used directly by a user.

In some embodiments, discarding the selected quantity of first virtual items causes a change in the display entry of the first virtual item in an inventory. In some embodiments, after the terminal device discards the selected quantity of first virtual items, the total quantity of the first virtual items displayed in the display entry of the first virtual item in the inventory changes if the selected quantity for the first virtual item is less than the total quantity of the first virtual items. The changed total quantity of the first virtual items=the total quantity of first virtual items in the inventory—the selected quantity for the first virtual item. If the selected quantity for the first virtual item is equal to the total quantity of the first virtual items, display of the display entry of the first virtual item is canceled in the inventory, or the display entry of the first virtual item is adjusted to an unavailable state (for example, the display entry of the first virtual item is set to gray).

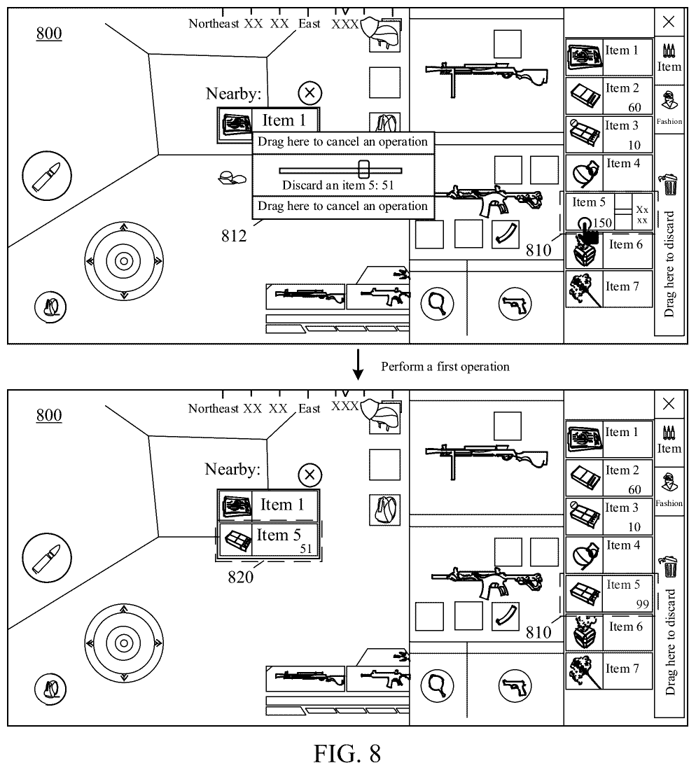

For example, FIG. 8 is a schematic diagram of discarding a first virtual item according to an embodiment of this disclosure. In FIG. 8, a terminal device displays a quantity selection interface 812 on a display interface 800 in response to a first sliding operation for a display entry 810 of a first virtual item, and determines a selected quantity for the first virtual item based on the first sliding operation. The selected quantity for the first virtual item currently displayed on the quantity selection interface 812 is 51, and a total quantity of the first virtual items displayed in the display entry 810 of the first virtual item is 150. In response to release of the first sliding operation, the terminal device discards the selected quantity of first virtual items and cancels display of the quantity selection interface 812. In this case, the selected quantity of first virtual items are displayed in a virtual environment, and a virtual object is visible. For example, the terminal device displays prompt information to the virtual object, and the prompt information 820 is configured for indicating that the selected quantity of first virtual items exist in the virtual environment. After the selected quantity of first virtual items are discarded, the total quantity of the first virtual items changed to 99 is displayed in the display entry 810 of the first virtual item.

In some embodiments, a user can control the virtual object to move in the virtual environment, and the virtual object may carry a specific quantity of virtual items during the movement. The inventory is configured to display the display entry of the virtual item carried by the virtual object. In some embodiments, to improve authenticity of game mechanics, a virtual prop carried by the virtual object has an upper weight limit or an upper space volume limit. After the selected quantity of the virtual items are discarded, the weight or the volume of the virtual item carried by the virtual object changes. A virtual backpack may be limited by setting a maximum quantity or a maximum volume of the virtual props that the virtual object can carry. In some embodiments, different types of virtual backpacks have different upper weight limits or upper capacity limits. The inventory is configured to display the display entry of the virtual item stored in the virtual backpack.

In some embodiments, in a case that the first virtual item has an associated virtual item, the terminal device may also discard the associated virtual item of the first virtual item. The associated virtual item of the first virtual item refers to a virtual item that can be superimposed with the first virtual item for use.

In some embodiments, the associated virtual item and the first virtual item may be superimposed for use, which can improve a use effect of the first virtual item. For example, the first virtual item is an attack prop, and the associated virtual item is an enhancement potion. Through superposition of the first virtual item and the associated virtual item, an attack attribute of the first virtual item can be improved.

In some embodiments, the first virtual item and the associated virtual item may be collaboratively used, which can achieve different use effects from that of using the first virtual item alone or using the associated virtual item alone. For example, the first virtual item is configured to increase a health point of the virtual object. The associated virtual item is configured to increase a movement speed of the virtual item. When the first virtual item and the associated virtual item are collaboratively used, the upper weight limit of the virtual item that can be carried by the virtual object may also be increased in addition to increasing the health point of the virtual object and increasing the movement speed of the virtual object.

In some embodiments, since the associated virtual item cannot be used alone, or an effect achievable when the associated virtual item is used alone is not as good as that achievable when the associated virtual item is used in combination with the first virtual item, a use value of the associated item in the inventory is reduced in a case that it is determined that the first virtual item is to be discarded. In this way, in a case that the first virtual item is discarded, a client automatically discards the associated virtual item, which helps reduce a selection operation and a discarding operation performed by the user for the associated virtual item, helps simplify the operation performed by the user, and achieves an effect of quickly organizing the virtual backpack.

In some embodiments, the discarding, by the terminal device, the associated virtual item of the first virtual item includes: determining, by the terminal device, a remaining quantity of the first virtual items based on the selected quantity for the first virtual item and the total quantity of the first virtual items; determining, by the terminal device, a to-be-discarded quantity for the associated virtual item based on a total quantity of the associated virtual items and the remaining quantity of the first virtual items; and discarding, by the terminal device, the to-be-discarded quantity for the associated virtual item.

In some embodiments, the remaining quantity of the first virtual items=the total quantity of the first virtual items—the selected quantity for the first virtual item. In some embodiments, the remaining quantity of the first virtual items is greater than or equal to 1.

The terminal device determines a to-be-retained quantity for the associated virtual item based on the total quantity of the associated virtual items and the remaining quantity of the first virtual items, and determines the to-be-discarded quantity for the associated virtual item based on the total quantity of the associated virtual items and the to-be-retained quantity for the associated virtual item. The to-be-retained quantity for the associated virtual item is configured for ensuring that there is a sufficient quantity of associated virtual items to be used in combination with the remaining quantity of the first virtual items.

In some embodiments, the determining, by the terminal device, a to-be-discarded quantity for the associated virtual item based on a total quantity of the associated virtual items and the remaining quantity of the first virtual items includes: determining a usage ratio of the first virtual item and the associated virtual item; and determining the to-be-discarded quantity for the associated virtual item based on the usage ratio, the total quantity of the associated virtual items, and the remaining quantity of the first virtual items.

For example, if the usage ratio of the first virtual item and the associated virtual item=1:2, the total quantity of the associated virtual items=10, and the remaining quantity of the first virtual items=2, the to-be-retained quantity for the associated virtual item is equal to 2*2=4. If the to-be-discarded quantity for the associated virtual item=6 (10−4), the terminal device also discards 6 associated virtual items after discarding the selected quantity of first virtual items.

In some embodiments, in the case of discarding the first virtual item, the terminal device determines whether the first virtual item has an associated virtual item. In a case that the first virtual item does not have the associated virtual item, the terminal device performs only the discarding operation on the first virtual item. In a case that the first virtual item has the associated virtual item, the terminal device discards the first virtual item and the associated virtual item.

In some embodiments, the terminal device displays a discarding query interface of the associated virtual item before discarding the associated virtual item. The terminal device discards the associated virtual item in response to a confirm operation for the discarding query interface. The confirm operation may include at least one of the following: a sliding operation, a clicking/tapping operation, a key operation, and the like.

Through the foregoing method, in a case that the first virtual item is discarded, the associated virtual item of the first virtual item is discarded to implement prediction of an operation to be performed by the user, which helps reduce a repeated discarding operation performed by the user for the associated virtual item, thereby reducing a processing duration for the virtual item displayed in the inventory by the user.

In some embodiments, after the terminal device displays the inventory, the technical solutions provided in the embodiments of this disclosure further include: controlling, by the terminal device in response to a second sliding operation for the display entry of the first virtual item, the display entry of the first virtual item to move as the second sliding operation progresses, a sliding direction of the second sliding operation being opposite to a sliding direction of the first sliding operation; and performing, by the terminal device, a first operation on all of the first virtual items in response to release of the second sliding operation and a release position of the second sliding operation being located in a target region. In this way, the first operation for all of the first virtual items may be quickly realized, which further improves convenience of the operation.

In some embodiments, the terminal device controls a movement speed of the display entry of the first virtual item based on a sliding speed of the second sliding operation, and controls a moving direction of the display entry of the first virtual item based on a sliding direction of the second sliding operation. The foregoing target region refers to a region in which all of the first virtual items are quickly selected and the first operation is performed. In some embodiments, the target region is displayed around the inventory to accelerate completion of a second operation by the user. For example, the target region is displayed on a right side of an inventory region, and a left edge of the target region is adjacent to a right edge of the inventory. A display position of the target region on a user interface may be determined based on an actual condition, which is not limited herein in this disclosure.

In some embodiments, the release of the second sliding operation means that the terminal device detects an end of the second sliding operation. For example, a finger of the user leaves a screen of the terminal device. The release position of the second sliding operation refers to a position where the finger of the user leaves the screen of the terminal device at the end of the second sliding operation. The release position of the second sliding operation may also be understood as a position where a screen pressure of the second operation on the terminal device is less than a pressure threshold, which is not limited herein in this disclosure.

The first operation corresponding to all of the first virtual items includes at least one of the following: discarding all of the first virtual items in the virtual environment, transferring all of the first virtual items to another virtual object, using all of the first virtual items, and the like. For example, the terminal device discards all first virtual items A in response to the release of the second sliding operation, and then display of a display entry of each of the first virtual items A is canceled in the inventory.

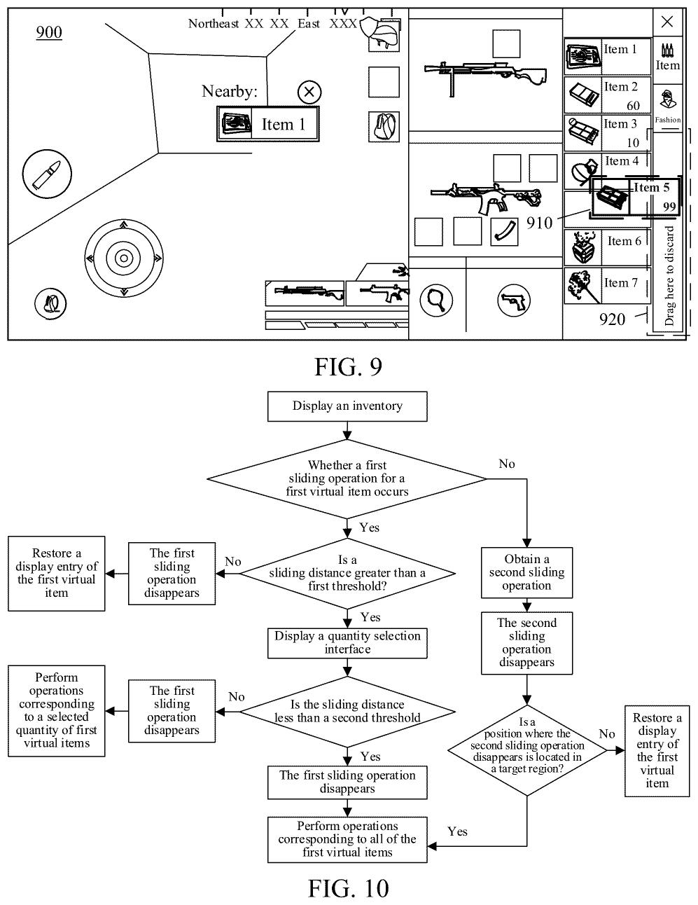

For example, FIG. 9 is a schematic diagram of a second sliding operation according to an embodiment of this disclosure. A display entry 910 of a first virtual item is displayed on a display interface 900. A terminal device moves the display entry 910 of the first virtual item toward a target region 920 in response to the second sliding operation for the display entry 910 of the first virtual item. If a release position of the second sliding operation is located in the target region 920, the terminal device discards all of the first virtual items. If the release position of the second sliding operation is in a display region of the inventory, or in another region on a user interface other than the target region 920, the terminal device moves the display entry 910 of the first virtual item back to the inventory for display. In this case, a display position of the first virtual item after being moved back to the inventory may be the same as a display position of the first virtual item in the inventory before the second sliding operation.

In some embodiments, a first sliding operation and the second sliding operation are continuously performed. Conversion between the first sliding operation and the second sliding operation may be realized by changing a sliding direction. For example, the first sliding operation is sliding from right to left, and the second sliding operation is sliding from left to right. During the first sliding operation, a user may convert the first sliding operation into the second sliding operation by changing a sliding direction of a finger, so that a method of performing an operation on all of the first virtual items is faster.

In some embodiments, after the terminal device displays a quantity selection interface corresponding to the first virtual item, the technical solutions provided in the embodiments of this disclosure further include: canceling, by the terminal device, the display of the quantity selection interface in response to a change in a sliding direction of the first sliding operation and the first sliding operation disappearing after the sliding direction of the first sliding operation changes, and skipping performing the first operation on a selected quantity of first virtual items.

In some embodiments, the change in the sliding direction of the first sliding operation may mean that an included angle between the sliding direction of the first sliding operation and a standard sliding direction is greater than or equal to an angle threshold. For example, if the standard sliding direction of the first sliding operation is horizontally to the left, and the angle threshold is 45°, the terminal device determines that the sliding direction of the first sliding operation changes in a case that the included angle between the sliding direction of the first sliding operation and the standard sliding direction is greater than or equal to 45°, and the terminal device cancels the display of the quantity selection interface and does not perform the first operation on the selected quantity of first virtual items. In some embodiments, in this case, the terminal device moves the display entry of the first virtual item back to the inventory for display.

In some embodiments, the change in the sliding direction of the first sliding operation may also mean that the changed sliding direction is perpendicular to the sliding direction of the first sliding operation before the change. For example, the sliding direction of the first sliding operation is horizontally to the left. The change in the sliding direction of the first sliding operation means that a sliding operation of the first sliding operation changes to sliding upward or sliding downward. The terminal device does not perform the first operation on the selected quantity of first virtual items in response to the change in the sliding direction of the first sliding operation.

In some embodiments, prompt information indicating cancellation of the operation is also displayed on the quantity selection interface. The prompt information indicating cancellation of the operation is configured for prompting to cancel the first sliding operation by changing the sliding direction of the first sliding operation. The prompt information indicating cancellation of the operation may be sliding up to cancel the first sliding operation, sliding down to cancel the first sliding operation, or the like.

For example, FIG. 10 is a schematic diagram of a method for controlling a virtual item according to an embodiment of this disclosure. A terminal device displays an inventory. In some embodiments, the inventory in a game has a fixed display region. The terminal device displays the inventory in the fixed display region in response to an operation of displaying the inventory (for example, an opening operation for a virtual backpack). The terminal device determines a display entry of a first virtual item in the inventory in response to an operation of determining the first virtual item. The terminal device detects whether a first sliding operation is performed on the first virtual item.

In a case that the first sliding operation occurs, the terminal device obtains a sliding distance of the first sliding operation in real time. The terminal device determines whether the sliding distance is greater than a first threshold. In a case that the sliding distance is less than the first threshold, the terminal device restores the display entry of the first virtual item in response to disappearance of the first sliding operation.

In a case that the sliding distance is greater than or equal to the first threshold, the terminal device displays a quantity selection interface. The quantity selection interface is configured to display a selected quantity for the first virtual item. The terminal device determines whether the sliding distance of the first sliding operation is less than a second threshold. The terminal device dynamically changes the selected quantity for the first virtual item based on the sliding distance of the first sliding operation.

In a case that the sliding distance of the first sliding operation is less than the second threshold, the terminal device performs a first operation on the selected quantity of first virtual items in response to release of the first sliding operation. In a case that the sliding distance of the first sliding operation is greater than or equal to the second threshold, the terminal device performs the first operation on all of the first virtual items in response to the release of the first sliding operation.

In a case that the first sliding operation for the first virtual item is not performed, the terminal device obtains a second sliding operation, and the terminal device determines, in response to release of the second sliding operation, whether a release position is in a target region.

In a case that the release position of the second operation is located in the target region, the terminal device performs the first operation on all of the first virtual items. In a case that the release position of the second operation is not located in the target region, the terminal device restores and displays the display entry of the first virtual item in the inventory.

Due to a change in a sliding direction of the first sliding operation, the terminal device does not perform the first operation on the selected quantity of first virtual items. In other words, the user can quickly cancel the first sliding operation by changing a direction of the first sliding operation. In this way, operation convenience during cancellation of the first sliding operation is improved. In addition, the method for performing the operation is helpful to avoid occurrence of accidental touch by the user during the cancellation of the first sliding operation, thereby helping improve user experience.

In some embodiments, after the terminal device displays the inventory, the technical solutions provided in the embodiments of this disclosure further include: determining, by the terminal device in response to a selection operation for display entries of a plurality of virtual items displayed in the inventory, the plurality of virtual items as a plurality of first virtual items; and displaying, by the terminal device, the quantity selection interface in response to the first sliding operation for any of the display entries of the first virtual items, the selected quantities respectively corresponding to the plurality of first virtual items being displayed on the quantity selection interface.

A selection operation for the display entries of the plurality of virtual items displayed in the inventory includes at least one of the following: a clicking/tapping operation or a ticking operation.

In some embodiments, the selected quantities for the plurality of first virtual items displayed in the inventory can be simultaneously determined through the first sliding operation. The terminal device determines, as the plurality of first virtual items in response to the clicking/tapping operation for the display entries of the plurality of virtual items displayed in the inventory, more than one virtual item clicked/tapped in a display region of the display entry. The terminal device displays the quantity selection interface in response to the first sliding operation for the display entry of any first virtual item, and determines the selected quantities respectively corresponding to the plurality of first virtual items based on the sliding distance of the first sliding operation.

In some embodiments, the terminal device determines a selected quantity for a first one of the first virtual items based on the sliding distance of the first sliding operation. The terminal device uses the selected quantity for the first one of the first virtual items as the selected quantity corresponding to the plurality of first virtual items.

In some embodiments, the terminal device determines the selected quantity corresponding to the plurality of first virtual items based on a selected quantity of reference virtual items. The reference virtual item is any one of the plurality of first virtual items. Specifically, the terminal device determines a selected quantity of reference objects based on the sliding distance of the first sliding operation, determines a selected ratio based on the selected quantity of the reference virtual items and a total quantity of the reference virtual items, and determines the selected quantities respectively corresponding to the plurality of first virtual items by using the selected ratio and total quantities respectively corresponding to the plurality of first virtual items.

For example, the selected ratio is equal to the selected quantity of the reference virtual items divided by the total quantity of the reference virtual items. For any first virtual item, the selected quantity corresponding to the first virtual item=the selected ratio*the total quantity of the first virtual items.

The terminal device displays the quantity selection interface in response to the first sliding operation for the display entry of the first virtual object selected by performing a last selection operation. The specific content of the process is similar to performing the first sliding operation for a display entry of the first one of the first virtual items. For details, reference is made to the foregoing embodiments.

The selected quantity of the plurality of first virtual items can be determined by performing a sliding operation, which helps improve efficiency of performing the first operation (such as a discarding operation) by the user for the virtual item displayed in the inventory.

In some embodiments, a display size of the display entry of the virtual item is related to the total quantity of the virtual items. For example, if a quantity of virtual items A is greater than a quantity of virtual items B, a display size of a display entry of each of the virtual items A is greater than or equal to a display size of a display entry of each of the virtual items B.

In this case, the display entries of the virtual items have a display range, and the display range is correspondingly limited by a maximum display size and a minimum display size. In some embodiments, the terminal device dynamically adjusts display sizes of the display entries of the virtual items in the inventory within a range of the display sizes based on a total quantity of virtual items.

The display sizes of the display entries of such virtual items are dynamically adjusted based on the total quantity of the virtual items, so that the user can have a more visual understanding of the total quantity of such virtual items in the inventory. A larger display size is convenient for the user to operate the display entries of such virtual items, and improves accuracy of an operation of controlling the quantity of such virtual items by the user.

In some embodiments, a display entry of at least one virtual item can be displayed in the inventory at a time. In more cases, display entries of a plurality of virtual items can be displayed in the inventory at a time. For example, display entries of 7 virtual items are displayed in the inventory.

The inventory may also have a sliding display function. The terminal device updates an edge of the inventory to display a display entry of another virtual item in response to a sliding operation for the inventory (for example, sliding up and down to move a slider displayed in the inventory). The display entry of another virtual item is not displayed in the inventory before the sliding operation is performed. The edge of the inventory may be below the inventory. In some embodiments, an arrangement order among display entries of different virtual items in the inventory may be determined based on the total quantity corresponding to the virtual items. For example, the display entries of the plurality of virtual items are arranged from top to bottom in the inventory. The terminal device may arrange the virtual items in the inventory in descending order of the total quantities. The display entries of the largest total quantity of virtual items are arranged at the bottom of the inventory.

In some embodiments, the terminal device displays the inventory on a user interface. A display entry of at least one virtual item is displayed in the inventory. In some embodiments, the inventory occupies a part of a display region on the user interface. The display region of the inventory on the user interface may be fixed. For example, the inventory is displayed in a left region of the user interface. The display region of the inventory in the user interface may also be customized by the user. For example, the user sets the display region of the inventory as an upper left corner on a game setting interface.

In some embodiments, in a case that the total quantity of the first virtual items is greater than 1, the technical solutions provided in the embodiments of this disclosure further include: displaying, by the terminal device, a scale identifier around a display entry of the first virtual item during movement of the display entry of the first virtual item as the first sliding operation progresses, the scale identifier being configured to divide the display entry of the first virtual item into p display parts, p being a positive integer.

The scale identifier is displayed on an edge of the display entry of the first virtual item. For example, 3 scale identifiers are displayed on a bottom edge of the display entry of the first virtual item, and the 3 scale identifiers divide the display entry of the virtual item into 4 display parts.

In some embodiments, different display parts correspond to different ranges of the selected quantities. For example, if the total quantity of the first virtual items is 4, p=2, and a maximum rated sliding distance is equal to a length of the display entry of the first virtual item, the display entry of the first virtual item is divided into a first display part and a second display part by 1 scale identifier. The range of the selected quantity of the virtual items corresponding to the first display part is [1, 2], and the range of the selected quantity of the virtual items corresponding to the second display part is [3, 4].

By displaying the scale identifier around the display entry of the virtual item, the user can be provided with a scale prompt during the first sliding operation by the user, so that the user can quickly determine the sliding distance of the first sliding operation corresponding to the selected quantity based on the prompt of the scale identifier.

In some embodiments, the terminal device determines an initial selected quantity of first virtual items based on a current game condition after displaying the quantity selection interface.

For example, in a case that users form a team, if the first virtual items belong to supply items, the terminal device determines half of the total quantity of the first virtual items as the initial selected quantity for the first virtual item. In this case, an initial position of the slider on a slider bar on the quantity selection interface can display a proportional relationship between the initial selected quantity for the first virtual item and the total quantity of the first virtual items.

Since the slider is not located on an end point of the slider bar in this case, the slider may slide to two sides of the slider bar, and then the terminal device may dynamically adjust the selected quantity for the first virtual item in response to the first sliding operation or the second sliding operation. For example, the terminal device controls the slider to move to the left in response to the first sliding operation, to increase the selected quantity for the first virtual item. In a case that a sliding distance of the second sliding operation is less than the second threshold, the terminal device controls the slider to move to the right in response to the second sliding operation, to reduce the selected quantity for the first virtual item. The sliding direction of the first sliding operation is opposite to a sliding direction of the second sliding operation. Both the first sliding operation and the second sliding operation herein may be configured for adjusting the position of the slider on the slider bar. The terminal device performs the first operation on the selected quantity of first virtual items in response to the release of the first sliding operation or the second sliding operation.

Through the method, the first virtual item (such as a virtual attack prop and a virtual health pack) may be provided to another user in time, which helps accelerate a process of determining the selected quantity of first virtual items by the user.

In some embodiments, in a scenario of picking up the virtual item, in a case that the terminal device determines that to-be-picked-up virtual items exceed an upper bearing limit of the virtual object, the terminal device may determine the selected quantity for the first virtual item based on attribute information of the to-be-picked-up virtual items. The attribute information of the to-be-picked-up virtual items refers to weight information or volume information of the to-be-picked-up virtual items. The to-be-picked-up virtual items refer to pickable virtual items displayed in the virtual environment.

In some embodiments, the virtual object operated by the user has an upper bearing limit (such as an upper weight bearing limit, an upper volume bearing limit, or an upper type bearing limit), which means that the virtual object can carry only a limited quantity of virtual items. In a case that the virtual item carried by the virtual object reaches or approaches the upper bearing limit, the terminal device cannot complete a pickup operation for the to-be-picked-up virtual items in response to the pickup operation. For example, the terminal device determines the selected quantity for the first virtual item based on the remaining bearing capacity of the virtual object and the weight information of the to-be-picked-up virtual items, so as to facilitate pickup of the to-be-picked-up virtual items by the virtual object.

In some embodiments, the terminal device may also determine the initial selected quantity for the first virtual item based on distances between the virtual object and the to-be-picked-up virtual items. In other words, the virtual object discards at least the initial selected quantity of first virtual items before picking up the to-be-picked-up virtual items. In some embodiments, in a case that the virtual object is within a pickup range of the to-be-picked-up virtual items, the terminal device determines the initial selected quantity for the first virtual item based on the attribute information of the to-be-picked-up virtual items. For example, the terminal device determines the initial selected quantity for the first virtual item based on the attribute information of the to-be-picked-up virtual items and attribute information of the first virtual items. For example, attribute information of a virtual item refers to weight information of the virtual item. If weight information of a to-be-picked-up virtual item is 3, and the weight information of the first virtual item is 1.5, the initial selected quantity for the first virtual item is 2.

In some embodiments, if a ratio of a value of the attribute information of the to-be-picked-up virtual item to the attribute information of the first virtual item is a decimal, the ratio is rounded, such as rounded up. For example, if the weight information of the to-be-picked-up virtual item is 5, and the weight information of the first virtual item is 2, the ratio of the value of the weight information of the to-be-picked-up virtual item to the weight information of the first virtual item is 2.5, and the initial selected quantity for the first virtual item is equal to 3 after the ratio is rounded up.

An apparatus embodiment of this disclosure is described below, which may be configured for performing the method embodiment of this disclosure. For details not disclosed in the apparatus embodiment of this disclosure, reference is made to the method embodiment of this disclosure.

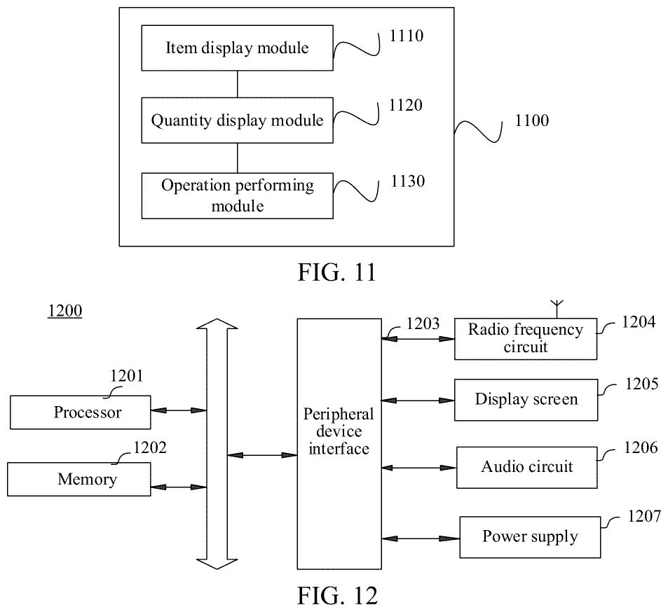

FIG. 11 is a block diagram showing an apparatus for controlling a virtual item according to an embodiment of this disclosure. The apparatus may be implemented as all or part of a terminal device through software, hardware, or a combination thereof. An apparatus 1100 may include an item display module 1110, a quantity display module 1120, and an operation performing module 1130.

The item display module 1110 is configured to display an inventory, a display entry of at least one virtual item being displayed in the inventory.

The quantity display module 1120 is configured to display a quantity selection interface corresponding to a first virtual item in response to a first sliding operation for a display entry of the first virtual item of the at least one virtual item.

The quantity display module 1120 is further configured to dynamically change a selected quantity for the first virtual item displayed on the quantity selection interface during movement of the display entry of the first virtual item as the first sliding operation progresses.

The operation performing module 1130 is configured to perform a first operation on the selected quantity of first virtual items in response to release of the first sliding operation.

In some embodiments, a slider bar and a slider located on the slider bar are displayed on the quantity selection interface, and a display position of the slider on the slider bar is configured to display a proportional relationship between the selected quantity for the first virtual item and a total quantity of the first virtual items. The quantity display module 1120 further includes a quantity determining unit and a quantity changing unit (not shown in FIG. 11).

The quantity determining unit is configured to determine the selected quantity for the first virtual item based on a sliding distance of the first sliding operation during the movement of the display entry of the first virtual item as the first sliding operation progresses.

The quantity changing unit is configured to dynamically change the display position of the slider on the slider bar as the selected quantity for the first virtual item changes, to display the proportional relationship between the selected quantity for the first virtual item and the total quantity of the first virtual items.

In some embodiments, a moving direction of the slider on the slider bar is consistent with a sliding direction of the first sliding operation.

In some embodiments, the quantity determining unit is configured to: obtain a ratio of the sliding distance of the first sliding operation to a rated maximum sliding distance; and determine the selected quantity for the first virtual item based on the ratio and the total quantity of the first virtual items.

In some embodiments, the quantity display module 1120 is further configured to: control, in response to the first sliding operation for the display entry of the first virtual item of the at least one virtual item, the display entry of the first virtual item to move as the first sliding operation progresses; and display the quantity selection interface corresponding to the first virtual item when a moving distance of the display entry of the first virtual item reaches a first threshold.

In some embodiments, the operation performing module 1130 is configured to discard the selected quantity of first virtual items.

In some embodiments, the apparatus 1100 further includes an associated discarding module (not shown in FIG. 11).

The associated discarding module is configured to discard associated virtual items of the first virtual items.

In some embodiments, the associated discarding module is further configured to: determine a remaining quantity of the first virtual items based on the selected quantity for the first virtual item and the total quantity of the first virtual items; determine a to-be-discarded quantity for the associated virtual item based on a total quantity of the associated virtual items and the remaining quantity of the first virtual items; and discard the to-be-discarded quantity for the associated virtual item.

In some embodiments, the apparatus 1100 further includes an entirety execution module (not shown in FIG. 11).

The entirety execution module is further configured to: control, in response to a second sliding operation for the display entry of the first virtual item, the display entry of the first virtual item to move as the second sliding operation progresses, a sliding direction of the second sliding operation being opposite to a sliding direction of the first sliding operation; and perform the first operation on all of the first virtual items in response to release of the second sliding operation and a release position of the second sliding operation being located in a target region.

In some embodiments, the apparatus 1100 further includes an execution cancellation module (not shown in FIG. 11).

The execution cancellation module is configured to cancel, in response to a change in a sliding direction of the first sliding operation and the first sliding operation disappearing after the sliding direction of the first sliding operation changes, the display of the quantity selection interface, and skip performing the first operation on the selected quantity of first virtual items.

In some embodiments, the apparatus 1100 further includes a multi-item selection module (not shown in FIG. 11).

The multi-item selection module is configured to determine, in response to a selection operation for display entries of a plurality of virtual items displayed in the inventory, the plurality of virtual items as a plurality of first virtual items; and the displaying a quantity selection interface corresponding to a first virtual item in response to a first sliding operation for the display entry of the first virtual item includes: displaying the quantity selection interface in response to the first sliding operation for any of the display entries of the first virtual items, the selected quantities respectively corresponding to the plurality of first virtual items being displayed on the quantity selection interface.

Based on the above, according to the technical solutions provided in the embodiments of this disclosure, the sliding operation is performed on the display entry of the first virtual item and released, so that the selected quantity for the first virtual item can be dynamically determined, and the first operation can be performed on the selected quantity of first virtual items. According to an aspect, in the embodiments of this disclosure, selection of the virtual item, adjustment of the selected quantity, and triggering of the first operation may be implemented only by performing a sliding operation. Through a single operation, the corresponding operation may be performed on some virtual items (such as discarding some virtual items), which fully improves convenience of the operation. According to an aspect, in the embodiments of this disclosure, coherence between a process of determining the selected quantity and performing the first operation can be improved, thereby improving fluency of the process of performing the first operation on the selected quantity of first virtual items. According to an aspect, compared with the tedious operation in the related art, only one sliding operation needs to be performed in the embodiments of this disclosure, which simplifies the operation and improves operation efficiency. In addition, since only one sliding operation needs to be performed, it is also helpful to reduce a probability of occurrence of a problem such as accidental touch, thereby increasing a success rate of the operation.

When the apparatus provided in the foregoing embodiment implements the functions of the apparatus, only division of the foregoing functional modules is described by using examples. In a practical application, the functions may be completed by different functional modules as required. To be specific, a content structure of a device is divided into different functional modules to complete all or part of the functions described above. In addition, the apparatus provided in the foregoing embodiment belongs to the same idea as the method embodiment. For a specific implementation process thereof, reference is made to the method embodiment. Details are not described herein again. For the beneficial effects of the apparatus provided in the foregoing embodiments, reference is made to the description of the method embodiment. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 12 is a structural block diagram of a terminal device according to an embodiment of this disclosure.

A terminal device 1200 may be an electronic device such as a mobile phone, a tablet computer, a game console, an e-book reader, a multimedia playback device, a wearable device, or a PC. The terminal device is configured to implement the method for controlling a virtual item provided in the foregoing embodiments. The terminal device may be the terminal device 10 shown in FIG. 1. Specifically, the terminal device 1200 includes a processor 1201 (i.e., processing circuitry) and a memory 1202 (i.e., a non-transitory computer-readable storage medium).

The processor 1201 may include one or more processing cores, such as a 4-core processor and an 8-core processor. The processor 1201 may be implemented in at least one hardware form of digital signal processing (DSP), a field programmable gate array (FPGA), and a programmable logic array (PLA). The processor 1201 may also include a main processor and a coprocessor. The main processor is a processor configured to process data in an awake state, and is also referred to as a central processing unit (CPU). The coprocessor is a low-power processor configured to process data in a standby mode. In some embodiments, the processor 1201 may be integrated with a graphics processing unit (GPU). The GPU is configured to render and draw content that needs to be displayed on a display screen. In some embodiments, the processor 1201 may further include an artificial intelligence (AI) processor. The AI processor is configured to process computing operations related to machine learning.

The memory 1202 may include one or more computer-readable storage media. The computer-readable storage medium may be tangible and non-transient. The memory 1202 may further include a high-speed random access memory (RAM) and a nonvolatile memory, such as one or more disk storage devices or flash storage devices. In some embodiments, the non-transient computer-readable storage medium in the memory 1202 has a computer program stored therein. The computer program is loaded and executed by the processor 1201 to implement the method for controlling a virtual item provided in the foregoing method embodiments.

In some embodiments, the terminal device 1200 further includes a peripheral device interface 1203 and at least one peripheral device. The processor 1201, the memory 1202, and the peripheral device interface 1203 may be connected through a bus or a signal line. Each peripheral device may be connected to the peripheral device interface 1203 through a bus, a signal line, or a circuit board. Specifically, the peripheral device includes at least one of a radio frequency circuit 1204, a display screen 1205, an audio circuit 1206, and a power supply 1207.

A person skilled in the art may understand that the structure shown in FIG. 12 does not constitute a limitation on the terminal device 1200. The terminal device may include more or fewer components than those shown in the figure, or some merged components, or different component arrangements.

An embodiment of this disclosure further provides a computer-readable storage medium. The computer-readable storage medium has a computer program stored therein. The computer program is loaded and executed by a processor to implement the method for controlling a virtual item provided in the foregoing method embodiments.

The computer-readable storage medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a read-only memory (ROM), an erasable programmable ROM (EPROM), an electrically erasable PROM (EEPROM), a flash memory or another solid-state memory technology, a digital versatile disc (DVD) or another optical memory, a tape cartridge, a magnetic cassette, a magnetic disk memory, or another magnetic storage device. Certainly, a person skilled in art may learn that the computer storage medium is not limited to the foregoing several types.

An embodiment of this disclosure further provides a computer program product, including a computer program, the computer program being stored in a computer-readable storage medium, and a processor being configured to read the computer program from the computer-readable storage medium and execute the computer program to implement the method for controlling a virtual item provided in the foregoing method embodiments.

According to the embodiments of this disclosure, a prompt interface and a pop-up window may be displayed or voice prompt information is outputted before relevant data of a user is collected and during collection of relevant data of the user. The prompt interface, the pop-up window, or the voice prompt information is configured for prompting that relevant data of the user is being collected currently, so that this application starts the relevant operations of obtaining user-related data only after obtaining a confirm operation performed by the user on the prompt interface or the pop-up window, or otherwise (i.e., when the confirm operation performed by the user on the prompt interface or the pop-up window is not obtained), the relevant operations of obtaining user-related data are ended, i.e., the user-related data is not obtained.

“Plurality of” mentioned in the specification means two or more. The term “and/or” is an association relationship for describing associated objects and represents that three relationships may exist. For example, A and/or B may represent the following three cases: only A exists, both A and B exist, and only B exists. The character “/” indicates an “or” relationship between the associated objects.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method for controlling a virtual item, comprising:
displaying an inventory including a plurality of virtual items;
displaying, by processing circuitry, a quantity selection interface for a first virtual item in response to a first sliding operation on a display element corresponding to the first virtual item from the plurality of virtual items;
selecting a quantity of the first virtual item on the quantity selection interface based on the first sliding operation on the display element; and
performing a first operation on a selected quantity of the first virtual item when the first sliding operation is released.

2. The method according to claim 1, wherein a slider bar and a slider on the slider bar are displayed on the quantity selection interface, position of the slider on the slider bar indicates a proportional relationship between the selected quantity of the first virtual item and a total quantity of the first virtual item; and
the method further comprising:
determining the selected quantity of the first virtual item based on a sliding distance of the first sliding operation on the display element of the first virtual item; and
adjusting the position of the slider on the slider bar as the selected quantity of the first virtual item changes, to display the selected quantity of the first virtual item and the total quantity of the first virtual item.

3. The method according to claim 2, wherein a moving direction of the slider on the slider bar corresponds directionally to a sliding direction of the first sliding operation.

4. The method according to claim 2, wherein the determining the selected quantity of the first virtual item comprises:
calculating a ratio of the sliding distance of the first sliding operation to a predetermined maximum sliding distance; and
determining the selected quantity of the first virtual item based on the ratio and the total quantity of the first virtual item.

5. The method according to claim 1, wherein the displaying the quantity selection interface comprises:
controlling movement of the display element of the first virtual item in response to the first sliding operation; and
displaying the quantity selection interface corresponding to the first virtual item when a moving distance of the display element of the first virtual item reaches a first threshold.

6. The method according to claim 1, wherein the performing the first operation on the selected quantity of the first virtual item includes discarding the selected quantity of the first virtual item.

7. The method according to claim 6, further comprising:
discarding an associated virtual item of the first virtual item.

8. The method according to claim 7, wherein the discarding the associated virtual item of the first virtual item comprises:
determining a remaining quantity of the first virtual item based on the selected quantity for the first virtual item and a total quantity of the first virtual item;
determining a to-be-discarded quantity of the associated virtual item based on a total quantity of the associated virtual item and the remaining quantity of the first virtual item; and
discarding the to-be-discarded quantity of the associated virtual item.

9. The method according to claim 1 further comprising:
controlling movement of the display element of the first virtual item in response to a second sliding operation with an opposite sliding direction to a sliding direction of the first sliding operation; and
performing the first operation on a total quantity of the first virtual item when the second sliding operation is released in a target region.

10. The method according to claim 1, further comprising:
canceling the display of the quantity selection interface and skipping the first operation on the selected quantity of the first virtual item when a sliding direction of the first sliding operation changes.

11. The method according to claim 1, further comprising:
selecting a plurality of first virtual items from the plurality of the virtual items based on a selection operation on a plurality of display elements of the plurality of virtual items in the inventory; and
displaying the quantity selection interface in response to the first sliding operation for at least one of the display elements of the plurality of the first virtual items, selected quantities of the display elements respectively corresponding to the plurality of first virtual items displayed on the quantity selection interface.

12. A data processing apparatus, comprising:
processing circuitry configured to:
display an inventory including a plurality of virtual items;
display a quantity selection interface for a first virtual item in response to a first sliding operation on a display element corresponding to the first virtual item from the plurality of virtual items;
select a quantity of the first virtual item on the quantity selection interface based on the first sliding operation on the display element; and
perform a first operation on a selected quantity of the first virtual item when the first sliding operation is released.

13. The data processing apparatus according to claim 12, wherein a slider bar and a slider on the slider bar are displayed on the quantity selection interface, position of the slider on the slider bar indicates a proportional relationship between the selected quantity of the first virtual item and a total quantity of the first virtual item; and
wherein the processing circuitry is configured to:
determine the selected quantity of the first virtual item based on a sliding distance of the first sliding operation on the display element of the first virtual item; and
adjust the position of the slider on the slider bar as the selected quantity of the first virtual item changes, to display the selected quantity of the first virtual item and the total quantity of the first virtual item.

14. The data processing apparatus according to claim 13, wherein a moving direction of the slider on the slider bar corresponds directionally to a sliding direction of the first sliding operation.

15. The data processing apparatus according to claim 13, wherein the processing circuitry is configured to:
calculate a ratio of the sliding distance of the first sliding operation to a predetermined maximum sliding distance; and
determine the selected quantity of the first virtual item based on the ratio and the total quantity of the first virtual item.

16. The data processing apparatus according to claim 12, wherein the processing circuitry is configured to:
control movement of the display element of the first virtual item in response to the first sliding operation; and
display the quantity selection interface corresponding to the first virtual item when a moving distance of the display element of the first virtual item reaches a first threshold.

17. The data processing apparatus according to claim 12, wherein the processing circuitry is configured to perform the first operation on the selected quantity of the first virtual item by discarding the selected quantity of the first virtual item.

18. The data processing apparatus according to claim 17, wherein the processing circuitry is configured to:
discard an associated virtual item of the first virtual item.

19. The data processing apparatus according to claim 18, wherein the processing circuitry is configured to:
determine a remaining quantity of the first virtual item based on the selected quantity for the first virtual item and a total quantity of the first virtual item;
determine a to-be-discarded quantity of the associated virtual item based on a total quantity of the associated virtual item and the remaining quantity of the first virtual item; and
discard the to-be-discarded quantity of the associated virtual item.

20. A non-transitory computer-readable storage medium storing instructions which, when executed by a processor, cause the processor to perform:
displaying an inventory including a plurality of virtual items;
displaying a quantity selection interface for a first virtual item in response to a first sliding operation on a display element corresponding to the first virtual item from the plurality of virtual items;
selecting a quantity of the first virtual item on the quantity selection interface based on the first sliding operation on the display element; and
performing a first operation on a selected quantity of the first virtual item when the first sliding operation is released.
